(19) United States
(12) Patent Application Publication
(10) Pub. No.: US 2013/0324598 A1
(43) Pub. Date: Dec. 5, 2013

(54) TREATING MYCOBACTERIAL INFECTION WITH CU+/++ BOOSTING THERAPEUTICS

(71) Applicants: Olaf Kutsch, Birmingham, AL (US); Frank Wolschendorf, Birmingham, AL (US)

(72) Inventors: Olaf Kutsch, Birmingham, AL (US); Frank Wolschendorf, Birmingham, AL (US)

(73) Assignee: THE UAB RESEARCH FOUNDATION, Birmingham, AL (US)

(21) Appl. No.: 13/985,711

(22) PCT Filed: Feb. 17, 2012
(86) PCT No.: PCT/US12/25600

§ 371 Date: Aug. 15, 2013

Related U.S. Application Data
(60) Provisional application No. 61/444,372, filed on Feb. 18, 2011.

(51) Int. Cl. C07F 1/08

(52) U.S. Cl. CPC C07F 1/08
USPC 514/499; 556/35; 435/32

(57) ABSTRACT

Provided herein are methods of treating a subject with a mycobacterial infection. The methods comprise administering to the subject a Cu^{+/++} boosting therapeutic. Also provided are compositions comprising a Cu^{+/++} boosting therapeutic. Further provided are methods of screening for a Cu^{+/++} boosting therapeutic.

### CROSS REFERENCE TO RELATED APPLICATIONS

This application claims the benefit of U.S. Provisional Application No. 61/444,372, filed on Feb. 18, 2011, which is incorporated by reference herein in its entirety.

### BACKGROUND

Mycobacterial diseases remain a major public health concern. Tuberculosis (TB) infections are more prevalent now than at any time in history. Mycobacterium tuberculosis, the pathogen that is responsible for human TB, uses diverse strategies to survive and persist within the host, thus escaping immune surveillance. With the emergence of multi-drug resistant and non-treatable drug resistant strains of M. tuberculosis, the current pharmacological arsenal to cure mycobacterial infections is on the verge of depletion. While Mycobacterium tubercolosis is the major health concern for humans, other Mycobacteriaceae cause disease in livestock, such as cattle.

### SUMMARY

Provided herein are methods of treating a subject with a mycobacterial infection. The methods comprise administering to the subject a Cu^{+/++} boosting therapeutic. Also provided are compositions comprising a Cu^{+/++} boosting therapeutic.

Further provided are methods for screening for a Cu^{+/++} boosting therapeutic. The screen comprises administering an agent to a Mycobacterium cultured in Cu^{+/++} low media and a Cu^{+/++} boosted media and determining a level of viability of the Mycobacterium in both culture conditions. A decrease in the level of viability in the Cu^{|/|} boosted media compared to the level of viability in the Cu^{+/++} low media indicates that the agent is a Cu'⁺⁺⁺ boosting therapeutic.

### FIGURE DESCRIPTION

FIG. 1 shows the Z-factor determination. Each well of a 96 well plate was loaded with Mycobacteria and gentamycin as an optimal inhibitor was added to 48 of the wells. In the upper left and the lower right quadrant gentamycin was added in a random manner and to all wells in the lower left quadrant. The upper right quadrant was left untreated.

FIG. 2 shows the determination of optimal detergent for AlamarBlue uptake into Mycobacterium tuberculosis. Mycobacterium tuberculosis was cultured in HdB medium supplemented with either tyloxapol (left column) or with Tween80 (right column) Cell numbers were titrated from 0.2 0D₆₀₀ in two-fold dilutions to determine optimal cell concentrations.

FIG. 3 shows the effect of pre-complexed disulfiram on mycobacteria and human monocytic cells. FIG. 3A shows human monocytic THP-1 cells or mycobacteria exposed to varying concentrations of Cu^{+/++}/disulfiram combinations. The viability of the cells was determined by AlamarBlue assay. FIG. 3B shows a graph demonstrating dose matrix experiments to specify the Cu^{-/++} effect of disulfiram on mycobacteria.

FIG. 4 shows a diagram of copper active drugs that are active against Mycobacterium tuberculosis.

FIG. 5 shows a graph demonstrating that the GTSM-Cu complex is active against Mycobacterium tuberculosis. The therapeutic index for GTSM (TD₅₀/IC₅₀) was estimated to be 25.

FIG. 6 shows a graph demonstrating that the ATSM-Cu complex is active against Mycobacterium tuberculosis. The therapeutic index for ATSM (TD₅₀/IC₅₀) was estimated to be greater than 16.

### DETAILED DESCRIPTION

The tolerance for Cu^{+/++} between mammalian organisms and Mycobacterium tuberculosis is different. Physiologically achievable, tolerable levels of Cu^{+/++} for humans are toxic to Mycobacterium tuberculosis if mechanisms that maintain Cu^{+/++} homeostasis are targeted by genetic manipulations. Thus Cu^{+/++} homeostasis presents itself as a previously unexplored drug target for a new class of anti-tuberculosis (TB) drugs. The idea is to boost intracellular Cu^{+/++} levels in Mycobacteria. This results in either direct cell death of the pathogen or hyper-sensitization of the pathogen to Cu^{+/++} or existing anti-mycobacterial (e.g., Mycobacterium tuberculosis (TB)) drugs by interfering with intrinsic or acquired resistance mechanisms.

Provided herein are methods of treating a subject with a mycobacterial infection. The methods comprise administering to the subject an effective amount of a Cu^{+/++} boosting therapeutic. Without intending to be limited by theory, administration of the Cu^{+/++} boosting therapeutic can result in the increase of intracellular Cu^{+/++} of the mycobacterial cell causing death of the mycobacterial cell without harm to the subject. This results in treatment of the mycobacterial infection.

Optionally, a mycobacterial infection is the result of an infection by a bacterium from the Mycobacteriaceae family. Members of the Mycobacteriaceae family include, but are not limited to, Mycobacterium tuberculosis, Mycobacterium bovis, Mycobacterium avium, Mycobacterium smegmatis, Mycobacterium gordonae, Mycobacterium hiberniae, Mycobacterium simiae, Mycobacterium lebrae, Mycobacterium marinum, and Mycobacterium ulcerans. Mycobacterial infections and their causes are known in the art. See, e.g., Ryan and Ray ed., Sherris Medical Microbiology 4^{th} Ed., McGraw Hill, Columbus, Ohio (2004); Parish and Brown ed., Mycobacterium: Genomics and Molecular Biology, Caister Academic Press (2009).

Optionally, the Cu^{+/-+} boosting therapeutic is selected from three groups of therapeutics. The three groups of therapeutics can, for example, include (1) a therapeutic pre-complexed with Cu^{+/++}; (2) a therapeutic capable of complexing with Cu^{+/+-} from the tissue, blood, or intracellular compartment (e.g., a phagosome); and (3) a therapeutic that interferes with Cu^{+/++} homeostasis without complexing with Cu^{+/++}. A therapeutic pre-complexed with Cu^{+/++} can, for example, comprise a pre-existing anti-tuberculosis (TB) therapeutic that is either able to complex Cu^{+/++} or has been structurally redesigned to complex with Cu^{+/++}. Anti-TB therapeutics are known in the art. See, e.g., U.S. Pat. Nos. 8,110,181; 8,088,823; 7,414,069; 7,195,769; 6,689,760; and 6,268,393; United States Patent Publications Nos. 20100172845; 20100113477; 20090275528; 20090192173; 20070270404; Van Calenbergh et al., Curr. Top. Med. Chem. (2012); Tripathi et al., Curr. Med. Chem. 19(4):488-517 (2012); Kaneko et al., Future Med. Chem. 3(11):1373-400 (2011). These references are incorporated herein in their entireties at least for anti-TB therapeutics.

Without intending to be limited by theory, the first two therapeutic groups transport Cu^{+/++} into the mycobacterial cell, which is either released or remains bound to the therapeutic compound. The third group of therapeutics would not complex with Cu^{|/||} but would rather aid in intracellular Cu^{+/-+} accumulation in the mycobacterial cell, thus resulting in death of the mycobacterial cell. By way of an example, with respect to Mycobacterium tuberculosis, as Mycobacterium tuberculosis is known to reside and replicate in blood and inside certain cellular compartments (e.g., the phagosome of macrophages), therapeutic compounds need to target free and intracellular Mycobacterium tuberculosis. To act on intracellular mycobacterial cells, therapeutic compounds of the first two groups have to cross the host-cell and the mycobacterial outer membrane/.cell wall to increase Cu^{|/||} levels within the Mycobacterium tuberculosis cells, thus causing cell death. The third group of therapeutics does not complex with Cu^{+/++} and acts by triggering Cu^{+/++} accumulation inside the mycobacterial pathogen, which is either caused by increasing influx or decreasing efflux of Cu^{-/++}. Nevertheless, these drugs also have to permeate into the macrophage phagosome to be active on intracellular pathogens. Compounds of the third group prevent Cu^{+/++} homeostasis in the Mycobacterium tuberculosis cells causing death of the mycobacterial cells. Alternatively, compounds of this group can increase phagosomal Cu+/++ concentration and thereby act to kill Mycobacterium tuberculosis cells.

Also provided herein are methods of screening for a Cu^{-/++} boosting therapeutic. The methods comprise administering an agent to a Mycobacterium cultured in two different culture conditions, wherein the first culture condition is a Cu^{+/-+} low/free media and the second culture condition is a Cu^{+/-+} boosted media. After administration of the agent, a level of viability of the Mycobacterium in both culture conditions is determined A decrease in the level of viability in the Cu^{+/++} boosted media compared to the level of viability in the Cu^{+/++} low media indicates that the agent is a Cu^{+/++} boosting therapeutic.

By way of an example, a Cu^{-/++} low/free media comprises about 0 to about 2 μM Cu^{+/+-}. Optionally, the Cu^{+/++} low/free media comprises 0.5 μM Cu^{+/-+}. Optionally, the Cu^{+/++} low/free media comprises 1.5 μM Cu^{|/|}. A Cu^{|/||} boosted media can, for example, comprise about 5 μM to 1 mM Cu^{+/++}. Optionally, the Cu^{-/++} boosted media comprises about 5 μM to about 25 μM Cu^{+/++}. The Cu^{+/++} boosted media can comprise about 15 μM Cu^{+/++}. The Cu^{-/++} boosted media can comprise about 10 μM Cu^{+/++}.

Optionally, the Mycobacterium is present in a Hartman's-deBont medium. Optionally, the Hartman's-deBont medium is supplemented with, glucose, Tyloxapol or Tween80. The medium cannot be Middlebrook 7H9 or Sauton's medium. The medium cannot comprise glycerol. The viability of the Mycobacterium can, for example, be determined 10 hours to 10 days after administration of the agent.

Optionally, the screen can be designed to identify Zn²⁺, Mg²⁺, or Fe²⁺-boosting therapeutics. Without intending to be limited by theory, the screen can be carried out under the same conditions, substituting Zn²⁺, Mg²⁺, or Fe²⁺for the Cu^{+/++} in both the low/free culture conditions and the boosted culture conditions. Levels of Zn²⁺, Mg²⁺, or Fe²⁺ for each culture condition can be determined by a person of skill in the art.

The anti-mycobacterial screen for identifying Cu^{-/++} boosting therapeutics can, for example, identify Cu^{+/++} boosting therapeutics from all three groups. Also enclosed are methods for determining the type of Cu^{-/++} boosting therapeutic identified by the screening methods described herein. Thus, provided are methods for identifying Cu^{+/+-} boosting therapeutics comprising Cu^{-/++} boosting therapeutics that require pre-complexing with Cu^{-/++}. The methods comprise premixing the compounds/agents with copper to achieve selective complexation with ionic copper (Cu^{+/++}), and determining the effect of these Cu^{+/-+} precomplexed-compounds on mycobacteria. An increase in mycobacterial cell death for pre-complexed Cu^{+/++} compounds as compared to a control indicates the Cu^{+/++} boosting therapeutic is in the first group of Cu^{+/++} boosting therapeutics. By way of an example, a control can comprise the same compound added to culture medium that contains elevated, but physiological relevant, Cu^{+/++} concentrations on mycobacteria.

Also provided are methods for identifying Cu^{+/++} boosting therapeutics comprising Cu^{+/++} boosting therapeutics that do not require pre-complexation with Cu^{+/++}. Cu^{+/++} boosting therapeutics that do not require pre-complexation with Cu^{|/||} are able to complex copper even in the presence of serum albumin and/or ceruloplasmin, which are the major copper binding proteins in human blood. The methods comprise adding the compounds/agents to media containing increasing concentrations of albumin or ceruloplasmin and determining the effect of the increasing amounts of albumin or ceruloplasmin on mycobacterial cell death. An increase in mycobacterial cell death as compared to a control indicates the compounds/agents is a Cu^{+/++} boosting therapeutic that does not require pre-complexation with Cu^{+/-+}. By way of an example, a control can comprise adding the same compound to the medium in the absence of albumin or ceruloplasmin. Optionally, the Cu^{+/++} concentration in the medium can be uniform( e.g., 5-25 μM). Optionally, albumin can be used at concentrations up to 70 mg/ml (higher end of normal range in blood). Optionally, ceruloplasmin can be used up to concentrations of 700 μg/ml. The compound/agent can, for example, be evaluated at concentrations between 1 nM and 10 μM. Titration curves from the evaluation can provide information on the capacity of the respective compound to complex Cu^{+/++} that is initially bound to albumin/ceruloplasmin. Compounds with a high Cu^{+/++} recruiting capacity do not require pre-complexation with Cu^{|/||} and are comprised in the second group of Cu^{|/||} boosting therapeutics.

Also provided are methods for identifying Cu^{+/++} boosting therapeutics comprising Cu^{+/++} boosting therapeutics that do not complex copper but inhibit cellular components of copper resistance pathways in the mycobacteria. The methods can comprise, for example, determining if the chemical structure of the compound/agent indicates a Cu^{+/++} complexing ability. The methods can comprise administering the compound/agent to media comprising a mutant mycobacteria, wherein the mutant mycobacteria is more susceptible to Cu^{|/||} than a wild-type mycobacteria, and determining the viability of the mutant mycobacteria as compared to a control. A decrease in the level of viability of the mutant mycobacteria as compared to the control, indicates a Cu^{+/++} boosting therapeutic that does not complex copper but inhibits cellular components of copper resistance pathways in the mycobacteria. By way of an example, a control can comprise administering the compound to the wild type mycobacteria and determining a level of viability of the wild type bacteria. Without intending to be limited by theory, while group I and group II compounds should have similar activity against wild-type and Cu^{+/-+} susceptible mutants, compounds from group III should be more effective on Cu^{+/++} susceptible mutants than on wild-type, as the group III compounds can directly interfere with the function of one or multiple components of known or unknown copper homeostasis and resistance pathways in the mycobacteria.

Further provided are Cu^{|/||} boosting therapeutics, Zn^{2|} boosting therapeutics, Mg^{2|} boosting therapeutics, or Fe²⁺ boosting therapeutics identified by the screening methods described herein.

Provided herein are methods of treating a mycobacterial infection in a subject. The methods, optionally, comprise identifying a subject with or at risk of developing a mycobacterial infection and administering to the subject a Cu^{+/++} boosting therapeutic, wherein the Cu^{+/++} boosting therapeutic comprises a compound represented by Formula I:

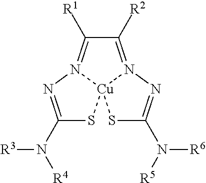

and pharmaceutically acceptable salts and prodrugs thereof. The Cu^{|/||} boosting therapeutic can, for example, boost intracellular levels of Cu^{+/++} in the mycobacterial organism.

In Formula I, R¹ and R² are each independently selected from hydrogen, halogen, hydroxyl, trifluoromethyl, cyano, nitro, substituted or unsubstituted alkyl, substituted or unsubstituted cycloalkyl, substituted or unsubstituted heteroalkyl, substituted or unsubstituted alkenyl, substituted or unsubstituted cycloalkenyl, substituted or unsubstituted heteroalkenyl, substituted or unsubstituted alkynyl, substituted or unsubstituted cycloalkynyl, substituted or unsubstituted heteroalkynyl, substituted or unsubstituted amino, substituted or unsubstituted aryl, substituted or unsubstituted heteroaryl, substituted or unsubstituted alkoxyl, substituted or unsubstituted aryloxyl, substituted or unsubstituted carbonyl, or substituted or unsubstituted carboxyl.

Also in Formula I, R³, R⁴, R⁵, and R⁶ are each independently selected from hydrogen, substituted or unsubstituted alkyl, substituted or unsubstituted cycloalkyl, substituted or unsubstituted heteroalkyl, substituted or unsubstituted alkenyl, substituted or unsubstituted cycloalkenyl, substituted or unsubstituted heteroalkenyl, substituted or unsubstituted alkynyl, substituted or unsubstituted cycloalkynyl, substituted or unsubstituted heteroalkynyl, substituted or unsubstituted aryl, or substituted or unsubstituted heteroaryl. In some examples, R⁴ and R⁵ are hydrogen.

In some examples, one or more of R¹, R², R³, R⁴, R⁵, and R⁶ can be hydrogen or substituted or unsubstituted alkyl. For example, one or more of R¹, R², R³, R⁴, R⁵, and R⁶ can be substituted or unsubstituted C₁₋₁₂ alkyl, C₁₋₆ alkyl, C₁₋₄ alkyl, or C₁₋₃ alkyl. Optionally, one or more of R¹, R², R³, R⁴, R⁵, and R⁶ is methyl.

In some examples, R³ and R⁶ are methyl and R¹, R², R⁴, and R⁵ are hydrogen. In some examples, R², R³, R⁶ are methyl and R¹, R⁴, and R⁵ are hydrogen. In some examples, R¹, R², R³, R⁶ are methyl and R⁴ and R⁵ are hydrogen. Specific examples of Formula I are as follows:

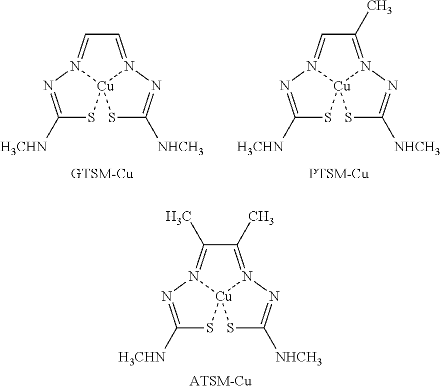

As used herein, the terms alkyl, alkenyl, and alkynyl include straight- and branched-chain monovalent substituents. Examples include methyl, ethyl, isobutyl, 3-butynyl, and the like. Ranges of these groups useful with the compounds and methods described herein include C₁-C₂₀ alkyl, C₂-C₂₀ alkenyl, and C₂-C₂₀ alkynyl. Additional ranges of these groups useful with the compounds and methods described herein include C₁-C₁₂ alkyl, C₂-C₁₂ alkenyl, C₂-C₁₂ alkynyl, C₁-C₆ alkyl, C₂-C₆ alkenyl, C₂-C₆ alkynyl, C₁-C₄ alkyl, C₂-C₄ alkenyl, and C₂-C₄ alkynyl. Heteroalkyl, heteroalkenyl, and heteroalkynyl are defined similarly as alkyl, alkenyl, and alkynyl, but can contain O, S, or N heteroatoms or combinations thereof within the backbone. Ranges of these groups useful with the compounds and methods described herein include C₁-C₂₀ heteroalkyl, C₂-C₂₀ heteroalkenyl, and C₂-C₂₀ heteroalkynyl. Additional ranges of these groups useful with the compounds and methods described herein include C₁-C₁₂ heteroalkyl, C₂-C₁₂ heteroalkenyl, C₂-C₁₂ heteroalkynyl, C₁-C₆ heteroalkyl, C₂-C₆ heteroalkenyl, C₂-C₆ heteroalkynyl, C₁-C₄ heteroalkyl, C₂-C₄ heteroalkenyl, and C₂-C₄ heteroalkynyl.

The terms cycloalkyl, cycloalkenyl, and cycloalkynyl include cyclic alkyl groups having a single cyclic ring or multiple condensed rings. Examples include cyclohexyl, cyclopentylethyl, and adamantanyl. Ranges of these groups useful with the compounds and methods described herein include C₃-C₂₀ cycloalkyl, C₃-C₂₀ cycloalkenyl, and C₃-C₂₀ cycloalkynyl. Additional ranges of these groups useful with the compounds and methods described herein include C₅-C₁₂ cycloalkyl, C₅-C₁₂ cycloalkenyl, C₅-C₁₂ cycloalkynyl, C₅-C₆ cycloalkyl, C₅-C₆ cycloalkenyl, and C₅-C₆ cycloalkynyl.

The terms heterocycloalkyl, heterocycloalkenyl, and heterocycloalkynyl are defined similarly as cycloalkyl, cycloalkenyl, and cycloalkynyl, but can contain O, S, or N heteroatoms or combinations thereof within the cyclic backbone. Ranges of these groups useful with the compounds and methods described herein include C₃-C₂₀ heterocycloalkyl, C₃-C₂₀ heterocycloalkenyl, and C₃-C₂₀ heterocycloalkynyl. Additional ranges of these groups useful with the compounds and methods described herein include C₅-C₁₂ heterocycloalkyl, C₅-C₁₂ heterocycloalkenyl, C₅-C₁₂ heterocycloalkynyl, C₅-C₆ heterocycloalkyl, C₅-C₆ heterocycloalkenyl, and C₅-C₆ heterocycloalkynyl.

Aryl molecules include, for example, cyclic hydrocarbons that incorporate one or more planar sets of, typically, six carbon atoms that are connected by delocalized electrons numbering the same as if they consisted of alternating single and double covalent bonds. An example of an aryl molecule is benzene. Heteroaryl molecules include substitutions along their main cyclic chain of atoms such as O, N, or S. When heteroatoms are introduced, a set of five atoms, e.g., four carbon and a heteroatom, can create an aromatic system. Examples of heteroaryl molecules include furan, pyrrole, thiophene, imadazole, oxazole, pyridine, pyrazole, and pyrazine. Aryl and heteroaryl molecules can also include additional fused rings, for example, benzofuran, indole, benzothiophene, naphthalene, anthracene, and quinoline.

The alkyl, alkenyl, alkynyl, aryl, heteroalkyl, heteroalkenyl, heteroalkynyl, heteroaryl, cycloalkyl, cycloalkenyl, cycloalkynyl, heterocycloalkyl, heterocycloalkenyl, or heterocycloalkynyl molecules used herein can be substituted or unsubstituted. As used herein, the term substituted includes the addition of an alkyl, alkenyl, alkynyl, aryl, heteroalkyl, heteroalkenyl, heteroalkynyl, heteroaryl, cycloalkyl, cycloalkenyl, cycloalkynyl, heterocycloalkyl, heterocycloalkenyl, or heterocycloalkynyl group to a position attached to the main chain of the alkyl, alkenyl, alkynyl, aryl, heteroalkyl, heteroalkenyl, heteroalkynyl, heteroaryl, cycloalkyl, cycloalkenyl, cycloalkynyl, heterocycloalkyl, heterocycloalkenyl, or heterocycloalkynyl, e.g., the replacement of a hydrogen by one of these molecules. Examples of substitution groups include, but are not limited to, hydroxyl, halogen (e.g., F, Br, Cl, or I), and carboxyl groups. Conversely, as used herein, the term unsubstituted indicates the alkyl, alkenyl, alkynyl, aryl, heteroalkyl, heteroalkenyl, heteroalkynyl, heteroaryl, cycloalkyl, cycloalkenyl, cycloalkynyl, heterocycloalkyl, heterocycloalkenyl, or heterocycloalkynyl has a full complement of hydrogens, i.e., commensurate with its saturation level, with no substitutions, e.g., linear decane (—(CH₂)₉—CH₃).

Optionally, the Cu^{+/-+} boosting therapeutic is a disulfiram pre-complexed with Cu^{+/++}. Optionally, the Cu^{+/++} boosting therapeutic is a complex of the following structure:

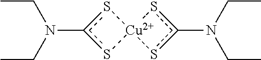

Optionally, the Cu^{+/-+} boosting therapeutic is a dithiocarbamate pre-complexed with Cu^{+/++}. Optionally, the dithiocarbamate is diethyl-dithiocarbamate.

The compounds described herein can be prepared in a variety of ways known to one skilled in the art of organic synthesis or variations thereon as appreciated by those skilled in the art. See, e.g., Gingras et al., Can. J. Chem. 40:1053-9 (1962) for methods of making GTSM and ATSM. The compounds described herein can be prepared from readily available starting materials. Optimum reaction conditions may vary with the particular reactants or solvents used, but such conditions can be determined by one skilled in the art.

Variations on the Formula I include the addition, subtraction, or movement of the various constituents as described for each compound. Similarly, when one or more chiral centers are present in a molecule, the chirality of the molecule can be changed. The compounds described herein can be isolated in pure form or as a mixture of isomers. Additionally, compound synthesis can involve the protection and deprotection of various chemical groups. The use of protection and deprotection, and the selection of appropriate protecting groups can be determined by one skilled in the art. The chemistry of protecting groups can be found, for example, in Wuts and Greene, Protective Groups in Organic Synthesis, 4th Ed., Wiley & Sons, 2006, which is incorporated herein by reference in its entirety.

Reactions to produce the compounds described herein can be carried out in solvents, which can be selected by one of skill in the art of organic synthesis. Solvents can be substantially nonreactive with the starting materials (reactants), the intermediates, or products under the conditions at which the reactions are carried out, i.e., temperature and pressure. Reactions can be carried out in one solvent or a mixture of more than one solvent. Product or intermediate formation can be monitored according to any suitable method known in the art. For example, product formation can be monitored by spectroscopic means, such as nuclear magnetic resonance spectroscopy (e.g., ¹H or ¹³C), infrared spectroscopy, spectrophotometry (e.g., UV-visible), or mass spectrometry, or by chromatography such as high performance liquid chromatograpy (HPLC) or thin layer chromatography.

The Cu^{+/++} boosting therapeutics described herein or derivatives thereof can be provided in a pharmaceutical composition. Depending on the intended mode of administration, the pharmaceutical composition can be in the form of solid, semi-solid or liquid dosage forms, such as, for example, tablets, suppositories, pills, capsules, powders, liquids, or suspensions, preferably in unit dosage form suitable for single administration of a precise dosage. The compositions will include a therapeutically effective amount of the compound described herein or derivatives thereof in combination with a pharmaceutically acceptable carrier and, in addition, may include other medicinal agents, pharmaceutical agents, carriers, or diluents. By pharmaceutically acceptable is meant a material that is not biologically or otherwise undesirable, which can be administered to an individual along with the selected compound without causing unacceptable biological effects or interacting in a deleterious manner with the other components of the pharmaceutical composition in which it is contained.

As used herein, the term carrier encompasses any excipient, diluent, filler, salt, buffer, stabilizer, solubilizer, lipid, stabilizer, or other material well known in the art for use in pharmaceutical formulations. The choice of a carrier for use in a composition will depend upon the intended route of administration for the composition. The preparation of pharmaceutically acceptable carriers and formulations containing these materials is described in, e.g., Remington's Pharmaceutical Sciences, 21st Edition, ed. University of the Sciences in Philadelphia, Lippincott, Williams & Wilkins, Philadelphia Pa., 2005. Examples of physiologically acceptable carriers include buffers such as phosphate buffers, citrate buffer, and buffers with other organic acids; antioxidants including ascorbic acid; low molecular weight (less than about 10 residues) polypeptides; proteins, such as serum albumin, gelatin, or immunoglobulins; hydrophilic polymers such as polyvinylpyrrolidone; amino acids such as glycine, glutamine, asparagine, arginine or lysine; monosaccharides, disaccharides, and other carbohydrates including glucose, mannose, or dextrins; chelating agents such as EDTA; sugar alcohols such as mannitol or sorbitol; salt-forming counterions such as sodium; and/or nonionic surfactants such as TWEEN® (ICI, Inc.; Bridgewater, N.J.), polyethylene glycol (PEG), and PLURONICS™ (BASF; Florham Park, N.J.).

Compositions containing the Cu^{+/++} boosting therapeutics described herein or derivatives thereof suitable for parenteral injection may comprise physiologically acceptable sterile aqueous or nonaqueous solutions, dispersions, suspensions or emulsions, and sterile powders for reconstitution into sterile injectable solutions or dispersions. Examples of suitable aqueous and nonaqueous carriers, diluents, solvents or vehicles include water, ethanol, polyols (propyleneglycol, polyethyleneglycol, glycerol, and the like), suitable mixtures thereof, vegetable oils (such as olive oil) and injectable organic esters such as ethyl oleate. Proper fluidity can be maintained, for example, by the use of a coating such as lecithin, by the maintenance of the required particle size in the case of dispersions and by the use of surfactants.

These compositions may also contain adjuvants such as preserving, wetting, emulsifying, and dispensing agents. Prevention of the action of microorganisms can be promoted by various antibacterial and antifungal agents, for example, parabens, chlorobutanol, phenol, sorbic acid, and the like. Isotonic agents, for example, sugars, sodium chloride, and the like may also be included. Prolonged absorption of the injectable pharmaceutical form can be brought about by the use of agents delaying absorption, for example, aluminum monostearate and gelatin.

Solid dosage forms for oral administration of the compounds described herein or derivatives thereof include capsules, tablets, pills, powders, and granules. In such solid dosage forms, the compounds described herein or derivatives thereof is admixed with at least one inert customary excipient (or carrier) such as sodium citrate or dicalcium phosphate or (a) fillers or extenders, as for example, starches, lactose, sucrose, glucose, mannitol, and silicic acid, (b) binders, as for example, carboxymethylcellulose, alignates, gelatin, polyvinylpyrrolidone, sucrose, and acacia, (c) humectants, as for example, glycerol, (d) disintegrating agents, as for example, agar-agar, calcium carbonate, potato or tapioca starch, alginic acid, certain complex silicates, and sodium carbonate, (e) solution retarders, as for example, paraffin, (f) absorption accelerators, as for example, quaternary ammonium compounds, (g) wetting agents, as for example, cetyl alcohol, and glycerol monostearate, (h) adsorbents, as for example, kaolin and bentonite, and (i) lubricants, as for example, talc, calcium stearate, magnesium stearate, solid polyethylene glycols, sodium lauryl sulfate, or mixtures thereof. In the case of capsules, tablets, and pills, the dosage forms may also comprise buffering agents.

Solid compositions of a similar type may also be employed as fillers in soft and hard-filled gelatin capsules using such excipients as lactose or milk sugar as well as high molecular weight polyethyleneglycols, and the like.

Solid dosage forms such as tablets, dragees, capsules, pills, and granules can be prepared with coatings and shells, such as enteric coatings and others known in the art. They may contain opacifying agents and can also be of such composition that they release the active compound or compounds in a certain part of the intestinal tract in a delayed manner. Examples of embedding compositions that can be used are polymeric substances and waxes. The active compounds can also be in micro-encapsulated form, if appropriate, with one or more of the above-mentioned excipients.

Liquid dosage forms for oral administration of the compounds described herein or derivatives thereof include pharmaceutically acceptable emulsions, solutions, suspensions, syrups, and elixirs. In addition to the active compounds, the liquid dosage forms may contain inert diluents commonly used in the art, such as water or other solvents, solubilizing agents, and emulsifiers, as for example, ethyl alcohol, isopropyl alcohol, ethyl carbonate, ethyl acetate, benzyl alcohol, benzyl benzoate, propyleneglycol, 1,3-butyleneglycol, dimethylformamide, oils, in particular, cottonseed oil, groundnut oil, corn germ oil, olive oil, castor oil, sesame oil, glycerol, tetrahydrofurfuryl alcohol, polyethyleneglycols, and fatty acid esters of sorbitan, or mixtures of these substances, and the like.

Besides such inert diluents, the composition can also include additional agents, such as wetting, emulsifying, suspending, sweetening, flavoring, or perfuming agents.

Suspensions, in addition to the active compounds, may contain additional agents, as for example, ethoxylated isostearyl alcohols, polyoxyethylene sorbitol and sorbitan esters, microcrystalline cellulose, aluminum metahydroxide, bentonite, agar-agar and tragacanth, or mixtures of these substances, and the like.

Compositions of the compounds described herein or derivatives thereof for rectal administrations are preferably suppositories, which can be prepared by mixing the compounds with suitable non-irritating excipients or carriers such as cocoa butter, polyethyleneglycol or a suppository wax, which are solid at ordinary temperatures but liquid at body temperature and therefore, melt in the rectum or vaginal cavity and release the active component.

Dosage forms for topical administration of the compounds described herein or derivatives thereof include ointments, powders, sprays, gels and the like. The compounds described herein or derivatives thereof are admixed under sterile conditions with a physiologically acceptable carrier and any preservatives, buffers, or propellants as may be required.

The term pharmaceutically acceptable salt as used herein refers to those salts of the compound described herein or derivatives thereof that are, within the scope of sound medical judgment, suitable for use in contact with the tissues of subjects without undue toxicity, irritation, allergic response, and the like, commensurate with a reasonable benefit/risk ratio, and effective for their intended use, as well as the zwitterionic forms, where possible, of the compounds described herein. The term salts refers to the relatively non-toxic, inorganic and organic acid addition salts of the compounds described herein. These salts can be prepared in situ during the isolation and purification of the compounds or by separately reacting the purified compound in its free base form with a suitable organic or inorganic acid and isolating the salt thus formed. Representative salts include the hydrobromide, hydrochloride, sulfate, bisulfate, nitrate, acetate, oxalate, valerate, oleate, palmitate, stearate, laurate, borate, benzoate, lactate, phosphate, tosylate, citrate, maleate, fumarate, succinate, tartrate, naphthylate mesylate, glucoheptonate, lactobionate, methane sulphonate, and laurylsulphonate salts, and the like. These may include cations based on the alkali and alkaline earth metals, such as sodium, lithium, potassium, calcium, magnesium, and the like, as well as non-toxic ammonium, quaternary ammonium, and amine cations including, but not limited to ammonium, tetramethylammonium, tetraethylammonium, methylamine, dimethylamine, trimethylamine, triethylamine, ethylamine, and the like. (See S. M. Barge et al., J. Pharm. Sci. (1977) 66, 1, which is incorporated herein by reference in its entirety, at least, for compositions taught herein.)

The active compound can be effective over a wide dosage range and is generally administered in a pharmaceutically effective amount. Those of skill in the art will understand that the specific dose level and frequency of dosage for any particular subject may be varied, and it will be understood that the amount of the compound actually administered will usually be determined by a physician, according to the relevant circumstances, including the condition to be treated, the chosen route of administration, the actual compound administered, the age, the activity of the specific compound employed, the metabolic stability and length of action of that compound, the species, age, weight, general health, sex and diet of the subject, the mode and time of administration, rate of excretion, drug combination, and response of the individual subject, the severity of the subject's symptoms, and the like.

As used throughout, subject can be a vertebrate, more specifically a mammal (e.g., a human, horse, cat, dog, cow, pig, sheep, goat, mouse, rabbit, rat, and guinea pig), birds, reptiles, amphibians, fish, and any other animal. The term does not denote a particular age or sex. Thus, adult and newborn subjects, whether male or female, are intended to be covered. As used herein, patient or subject may be used interchangeably and can refer to a subject with a disease or disorder (e.g., mycobacterial infection). The term patient or subject includes human and veterinary subjects.

The methods and agents as described herein are useful for therapeutic treatment. Therapeutic treatment involves administering to a subject a therapeutically effective amount of one or more of the agents described herein, optionally, after diagnosis of a mycobacterial infection in the subject.

As used herein the terms treatment, treat, or treating refers to a method of reducing the effects of a disease or condition or symptom of the disease or condition. Thus in the disclosed method, treatment can refer to a 10%, 20%, 30%, 40%, 50%, 60%, 70%, 80%, 90%, or 100% reduction in the severity of an established disease or condition or symptom of the disease or condition. For example, a method for treating a disease is considered to be a treatment if there is a 10% reduction in one or more symptoms of the disease in a subject as compared to a control. Thus the reduction can be a 10%, 20%, 30%, 40%, 50%, 60%, 70%, 80%, 90%, 100%, or any percent reduction in between 10% and 100% as compared to native or control levels. It is understood that treatment does not necessarily refer to a cure or complete ablation of the disease, condition, or symptoms of the disease or condition.

Disclosed are materials, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutations of these compounds may not be explicitly disclosed, each is specifically contemplated and described herein. For example, if a method is disclosed and discussed and a number of modifications that can be made to a number of molecules including the method are discussed, each and every combination and permutation of the method, and the modifications that are possible are specifically contemplated unless specifically indicated to the contrary. Likewise, any subset or combination of these is also specifically contemplated and disclosed. This concept applies to all aspects of this disclosure including, but not limited to, steps in methods using the disclosed compositions. Thus, if there are a variety of additional steps that can be performed, it is understood that each of these additional steps can be performed with any specific method steps or combination of method steps of the disclosed methods, and that each such combination or subset of combinations is specifically contemplated and should be considered disclosed.

Publications cited herein and the material for which they are cited are hereby specifically incorporated by reference in their entireties.

### EXAMPLES

### Example 1

### Drug Screening Assay to Identify Cu^{+/++} Boosting Drugs/Compounds for Treating Mycobacterial Infections

Description of Drug Screening Assay. To identify Cu^{+/++}-boosting drugs/compounds, two replica 96-well plates were prepared to which compounds were added in each well. One replica plate received Cu^{+/++} to give a final concentration of 10 μM (Cu^{+/-+} boosted condition(Cu^{+/++}ₘₐₓ) The other replica plate did not receive any further Cu^{+/++} (Cu^{+/++} low/free condition (Cu^{+/++}ₘₐₓ)). Mycobacteria were cultured in Hartman's-deBont medium supplemented with 0.5% [w/v] glucose, 0.025% Tyloxapol and were loaded into each well of a 96 well plate. Mycobacteria used can be, but are not limited to, Mycobacterium smegmatis, avirulent Mycobacteria tuberculosis strains (mc²6230, mc²6206) or attenuated, virulent, multidrug-resistant, or extensively drug-resistant Mycobacteria tuberculosis strains. Depending on the mycobacterial species, assay plates were incubated for 12 hours to 8 days prior to the addition of AlamarBlue, a metabolic dye that changes color from blue to pink in the presence of metabolically active organisms. Upon entering cells (Alamar Blue) resazurin (blue) is converted to resorufin (red-pink), which produces a very bright red fluorescence. This change was quantitatively detected using a plate-reader. AlamarBlue was added as a 50/50 mixture with 10% Tween80 (FIG. 2). This was essential to optimize AlamarBlue uptake into mycobacteria.

By comparing the Cu^{+/++} with the Cu^{+/++}ₘₐₓ plates for the corresponding compounds, the screen identified compounds that only act as antimicrobials in the presence of Cu^{+/++}. Compounds that kill under both conditions were not considered for further development. To minimize the number of false negative compounds the screen was performed as a high-low screen with respect to compound concentrations. To this end, a total of four 96 well plates were generated (drug^{high}/Cu^{+/++}ₘᵢₙ, drug^{high}/Cu^{+/++}ₘₐₓ, drug^{low}/Cu^{+/++}ₘᵢₙ, drug^{low}/Cu^{+/++}ₘₐₓ). For the data acquisition, metabolic activity indicated by changes in fluorescence was measured using a fluorescence plate-reader.

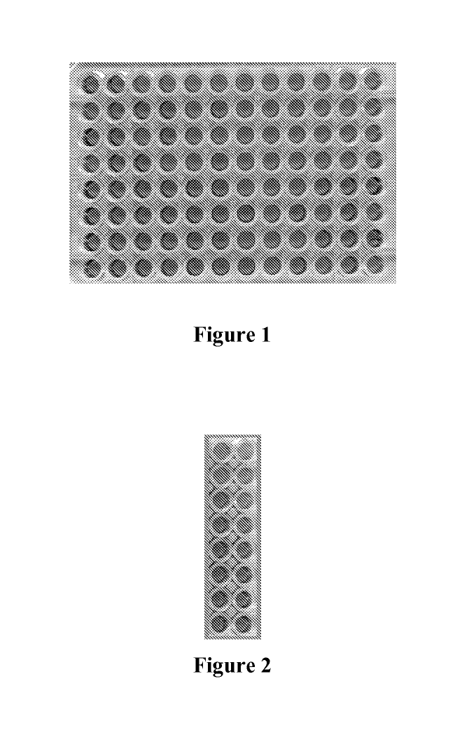

Assay Accuracy. Assay accuracy is best described by the Z′-factor. The experimentally determined Z′ factor is a dimensionless statistical value designed to reflect the dynamic range as well as the variation of the assay. It calculates as Z′=1−(3σₚ+3σhd n)/|μₚ−μₙ|). With 3σₙ representing the standard deviation of the negative control samples, 3σₚ representing the standard deviation of the positive samples, μₙ the mean of the negative control samples and μₚ the mean of the positive samples. Z′=1 would be an ideal assay and 1>Z′>0.5 are considered very good to excellent assays. The Z′ factor calculated for the assay was 0.93 (FIG. 1).

Medium Properties. Hartman's-deBont medium was the ideal medium for the described drug screen. Other media, such as Middlebrook 7H9 or Sauton's medium, which are most commonly used for mycobacterial cell culture are not suitable for the detection of Cu^{+/++}-boosting drug effects. Copper toxicity is a function of its chemical state, which is influenced by the chemical environment provided by the growth media. Free amino acids, complex nutrient extracts, and proteins are detrimental components of other media, which influence the chemical state of copper ions. Hartman's-deBont medium complemented with glucose and tyloxapol was used in the present drug screening assay. Hartman's-deBont medium was complemented with tyloxapol as detergent to prevent clumping.

Hartman's-deBont medium contained 0.8 μM of Cu^{+/++} in the Cu^{+/++}ₘᵢₙ version, and 10 μM in the Cu^{|/||}ₘₐₓ version with physiological normal Cu^{|/||} concentrations in tissue/blood being in the range of 10-25 uM Cu^{-/++}.

The drug screen was further developed to screen for drug combinations of identified Cu^{+/++}-boosting compounds, based on the idea that targeting Cu^{+/+-} homeostasis with Cu^{+/++}-boosting drugs will weaken the resistance of Mycobacterium tuberculosis to other drugs that were inefficient due to intrinsic or acquired resistance mechanisms.

The proposed drug screen is not limited to the utilization of Cu^{+/++}, but can also include other biologically relevant metal ions for which bacteria exhibit a certain level of hypersensitivity relative to eukaryotic cells. These include, but are not limited to Zn²⁺, Mg²⁺, or Fe²⁺.

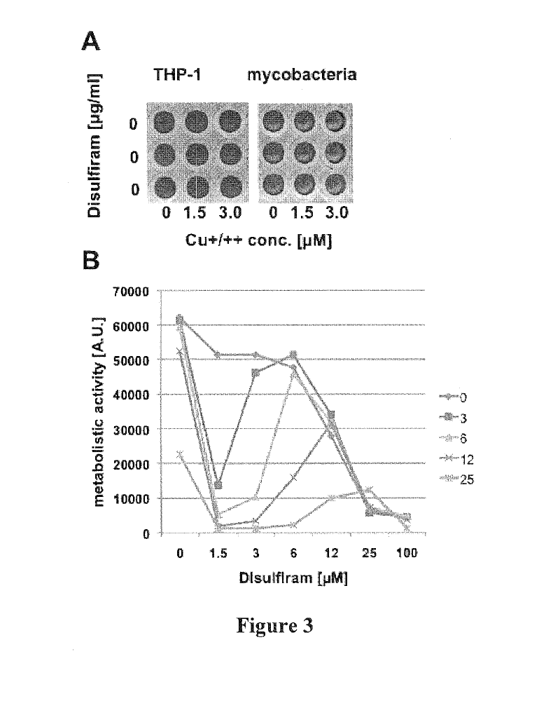

Identified Cu^{+/++}-boosting compounds. During the drug screen, disulfiram was identified as an FDA approved drug that acts potently against mycobacteria drug when pre-complexed with Cu^{+/++}. When disulfiram was titrated into a dose matrix with Cu^{+/-+}, pre-complexed disulfiram exhibited significantly higher toxicity for mycobacteria than for a human monocytic cell line THP-1 (FIG. 3A). Dose matrix experiments indicated that an optimal disulfiram/Cu^{+/++} concentration is found in the range of physiological Cu^{+/++} concentrations (FIG. 3B).

### Example 2

### Copper Complexed Compounds are Active Against Mycobacterium tuberculosis

### Materials and Methods

Preparation of GTSM and ATSM working solutions. GTSM and ATSM were synthesized as described previously (Gingras et al., Can. J. Chem. 40:1053-9 (1962)). The compounds were dissolved in 100% DMSO at a concentration of 400 μM (solution A (400 μM GTSM in 100% DMSO), and solution B (400 μM ATSM in 100% DMSO)). For the assay 6 different working solutions (WSol) were prepared: WSol Al (mix equal parts solution A and solution D (400 μM CuSO₄+4mM sodium acetate pH 5.2)); WSol A2 (mix equal parts solution A and solution C (4 mM Sodium Acetate pH 5.2)); WSol B1 (mix equal parts solution B and solution D); WSol B2 (mix equal parts solution B and solution C); WSol C1 (mix equal parts 100% DMSO and solution D); and WSol C2 (mix equal parts 100% DMSO and solution C)). The working solutions contain the GTSM or ATSM compounds in the absence (WSol A2, B2) or presence (WSol Al, B1) of copper or the appropriate controls lacking the compounds (WSol C1, C2) . The formation of the copper complex in WSol A2 and B2 was indicated by a sudden color change as previously described (Dearling et al., Eur. J. Nucl. Med. 25(7):788-92 (1998); Xiao et al., Inorg. Chem. 47(10):4338-47 (2008)).

Anti-mycobacterial activity of ATSM and GTSM. WSol A1, A2, B1, B2 were diluted eight times in two-fold increments using Solution E (mix equal parts of 100% DMSO with solution C) or F (mix equal parts of 100% DMSO with solution D) as diluents, respectively. All prepared dilutions of WSol A1, A2, B1, B2 as well as WSol C1 and C2 represent 20-fold solutions. Accordingly, 10 μL of those were added to 90 μL of deionized water in a 96 well plate and mixed with 100 μL of 2-fold Hartman's-deBont (Hdb) medium containing approximately 5×10⁵ cells per ml M. smegmatis (SMR5) or M. tuberculosis (mc²6230). The 96 well plates where sealed with parafilm, wrapped in aluminum foil and placed in a sealed plastic bag to prevent evaporation. M. smegmatis was incubated for 18 hours at 37° C. (shaking at 100-200 rpm). Alamar Blue dye (AbD Serotec) was prepared by mixing 1 part AlamarBlue dye and 1 part 10% Tween80 and 40 μL were added to each well. Incubation of the compounds and bacteria was continued at 37° C. for 1 hour (M. smegmatis) or 12 hours (M. tuberculosis) or AlamarBlue dye conversion was recorded kinetically for up to 48 hours or at least until fluorescence intensity of control wells reached its maximum.

The composition of each well is as follows: 1X glycerol free HdB medium (Smeulders et al, 1999); 0.5% Glucose; 2.5% DMSO; 100 uM Sodium Acetate; 0.02% Tyloxapol; ATSM or GTSM at concentrations of: 0, 0.075, 0.15, 0.3, 0.6, 1.25, 2.5, 5, 10 μM; and 10 μM copper or no copper in the copper free controls that were prepared using Solution C or E.

### Results

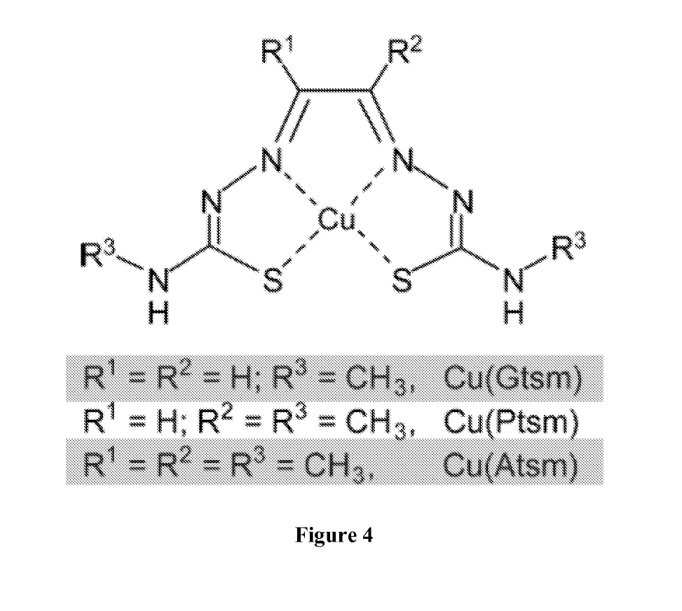

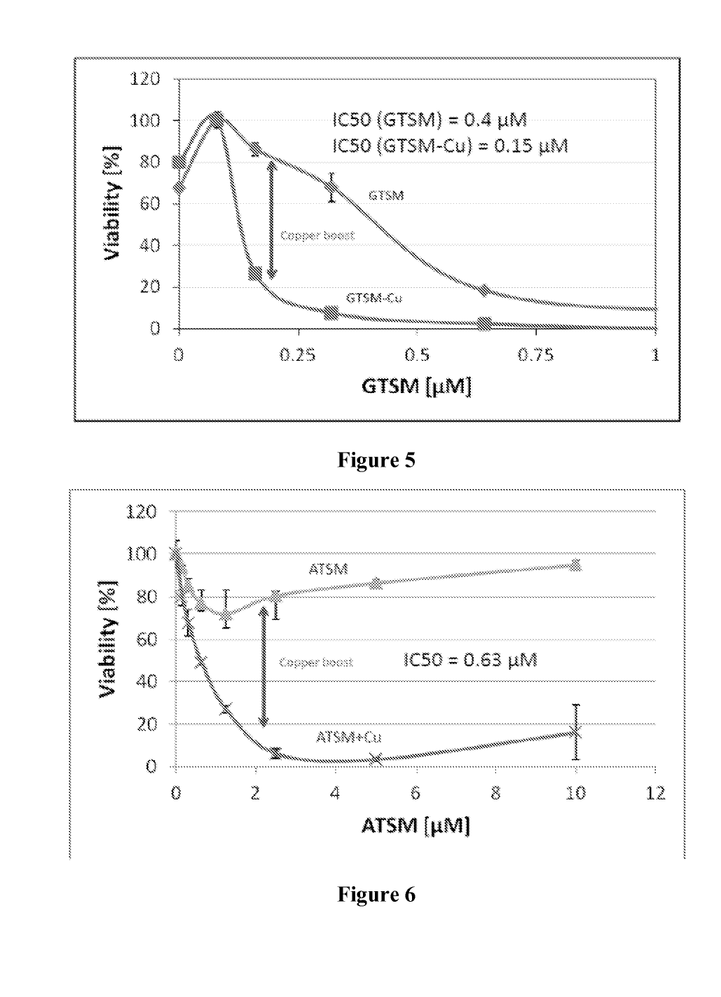

To determine the anti-mycobacterial effect of the GTSM or ATSM and their respective copper complexes (FIG. 4), fluorescence was measured 1 hour (M. smegmatis) or 12 hours (M. tuberculosis) after AlamarBlue addition. Fluorescence intensity was a measure of cell viability and was shown as percent of viability of untreated cells that were not exposed to GTSM-Cu or ATSM-Cu. The inhibitory concentration (IC50) was estimated based on the shape of the curve, and indicates the concentration at which a 50% decrease in viability is observed, and the therapeutic index was estimated based on the lethal dose (LD50) of these compounds for macrophages, which indicates a 50% reduction in viability. The LD50 of GTSM towards macrophages, the main residential cell type for M. tuberculosis, is 10 μM. However, ATSM did not show any toxicity up to 10 μM. Higher concentrations of ATSM could not be tested due to limited solubility. It was shown that Mycobacterium tuberculosis cell viability was decreased significantly upon the treatment with GTSM (FIG. 5) and ATSM (FIG. 6) complexed with copper. The therapeutic index for the GTSM system was estimated to be 25, and the therapeutic index for ATSM was estimated to be 16. The therapeutic index calculates as TI=LD50/IC50

### Example 3

### Identification of Mechanism of Action of Cu^{+/++} Boosting Therapeutics Identified by Screen

The anti-mycobacterial drug screen for Cu^{+/++} boosting compounds will recognize all three classes of Cu^{+/-+} boosting therapeutics. To distinguish the mode of action for each therapeutic, the therapeutic is subjected to various verification assays/screens.

To determine if the therapeutic is in the first group of therapeutics, which comprises Cu^{+/++} boosting therapeutics that require pre-complexation with Cu^{+/-+}, compounds are premixed under relevant experimental conditions with copper to achieve selective complexation of ionic copper (Cu^{-/++}). The effect of these Cu^{+/++} precomplexed-compounds on mycobacteria are then compared to the effect of the same compounds added to culture medium that contains elevated, but physiological relevant Cu^{+/++} concentrations on mycobacteria. Compounds that show significantly greater efficacy when pre-complexed with Cu^{+/++} in these experiments are further pursued as compounds that require Cu^{+/++} during a subsequent drug development process.

The second group of therapeutics comprises Cu^{+/++} boosting therapeutics that do not require pre-complexation with Cu^{+/++}. These compounds are able to complex copper even in the presence of serum albumin and/or ceruloplasmin and can be distinguished from group I compounds in a verification assay/screen, in which the anti-mycobacterial activity of hit compounds are evaluated in the presence of increasing concentrations of albumin and ceruloplasmin, the major copper binding proteins in human blood. In these assays, none of the compounds are precomplexed with Cu^{+/++} and the Cu^{+/++} concentration in the medium will be uniform (5-25 μM). Albumin is used at concentrations up to 70 mg/ml (higher end of normal range in blood). Ceruloplasmin is used up to concentrations of 700 μg/ml. Compound concentrations are evaluated at concentration between 1 nM and 10 μM. The resulting titration curves provide information on the capacity of the respective compound to complex Cu^{/||} that is initially bound to albumin/ceruloplasmin. Compounds with a high Cu^{+/++} recruiting capacity do not require pre-complexation with Cu^{+/+-}.

The third group of therapeutics comprise Cu+/++ boosting therapeutics that do not complex copper but inhibit cellular components that maintain copper homeostasis. These therapeutics can be distinguished from group I and group II compounds if their chemical structure does not indicate a Cu^{+/++} complexing ability. These therapeutics are verified by evaluating their anti-mycobacterial properties against existing mutants of mycobacteria that are more susceptible to Cu^{+/++} than the appropriate wild-type mycobacteria. While group I and group II compounds should have similar activity against wild-type and Cu^{+/++} susceptible mutants, compounds from group III should be more effective on Cu^{+/++} susceptible mutants than on wild-type as they would directly interfere with the function of one or multiple components of known or unknown copper homeostasis and resistance pathways.

1. A method of treating a subject with a mycobacterial infection, the method comprising administering to the subject a Cu^{+/++} boosting therapeutic.

2. The method of claim 1, wherein the Cu^{+/++} boosting therapeutic is selected from the group consisting of a therapeutic pre-complexed with Cu^{+/++}; a therapeutic capable of complexing Cu^{+/-+} from tissue, blood, or intracellular compartments; and a therapeutic that interferes with Cu^{+/++} homeostatsis without complexing Cu^{-/++}.

3. The method of claim 2, wherein the Cu^{+/++} boosting therapeutic is a therapeutic pre-complexed with Cu²⁻.

4. The method of claim 3, wherein the Cu^{+/++} boosting therapeutic is a complex of the following structure: 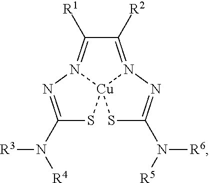
wherein:
R^{l} and R² are each independently selected from hydrogen, halogen, hydroxyl, trifluoromethyl, cyano, nitro, substituted or unsubstituted alkyl, substituted or unsubstituted cycloalkyl, substituted or unsubstituted heteroalkyl, substituted or unsubstituted alkenyl, substituted or unsubstituted cycloalkenyl, substituted or unsubstituted heteroalkenyl, substituted or unsubstituted alkynyl, substituted or unsubstituted cycloalkynyl, substituted or unsubstituted heteroalkynyl, substituted or unsubstituted amino, substituted or unsubstituted aryl, substituted or unsubstituted heteroaryl, substituted or unsubstituted alkoxyl, substituted or unsubstituted aryloxyl, substituted or unsubstituted carbonyl, or substituted or unsubstituted carboxyl; and
R³, R⁴, R⁵, and R⁶ are each independently selected from hydrogen, substituted or unsubstituted alkyl, substituted or unsubstituted cycloalkyl, substituted or unsubstituted heteroalkyl, substituted or unsubstituted alkenyl, substituted or unsubstituted cycloalkenyl, substituted or unsubstituted heteroalkenyl, substituted or unsubstituted alkynyl, substituted or unsubstituted cycloalkynyl, substituted or unsubstituted heteroalkynyl, substituted or unsubstituted aryl, or substituted or unsubstituted heteroaryl.

5. The method of claim 4, wherein R¹, R², R³, R⁴, R⁵, and R⁶ are each independently selected from hydrogen and substituted or unsubstituted C₁-C₆ alkyl.

6. The method of claim 4, wherein R⁴ and R⁵ are hydrogen.

7. The method of claim 4, wherein R¹, R², R³, and R⁶ are each independently selected from hydrogen and methyl.

8. The method of claim 3, wherein the Cu^{+/++} boosting therapeutic has the following structure:

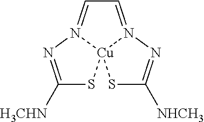

9. The method of claim 3, wherein the Cu^{+/++} boosting therapeutic has the following structure:

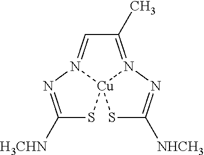

10. The method of claim 3, wherein the Cu^{+/++} boosting therapeutic has the following structure:

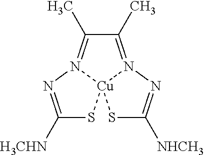

11. The method of claim 3, wherein the Cu^{+/++} boosting therapeutic is disulfiram pre-complexed with Cu^{-/++}.

12. The method of claim 11, wherein the Cu^{+/++} boosting therapeutic is a complex of the following structure:

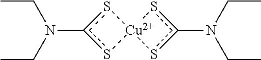

13. The method of claim 1, further comprising administering to the subject a supplement capable of increasing Cu^{+/-+} availability.

14. The method of claim 1, wherein the mycobacterial infection is the result of an infection by a bacteria from the Mycobacteriaceae family.

15. A composition comprising a Cu^{+/++} boosting therapeutic.

16. The composition of claim 15, wherein the Cu+/++ boosting therapeutic is selected from the group consisting of a therapeutic pre-complexed with Cu^{+/++}; a therapeutic capable of complexing Cu^{+/++} from tissue, blood, or intracellular compartments; and a therapeutic that interferes with Cu^{+/++} homeostatsis without complexing Cu^{-/++}.

17. The composition of claim 16, wherein the Cu^{+/++} boosting therapeutic is a therapeutic pre-complexed with Cu^{-/++}.

18. The composition of claim 17, wherein the Cu^{+/++} boosting therapeutic is a complex of the following structure: 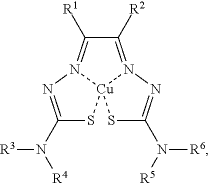
wherein:
R¹ and R² are each independently selected from hydrogen, halogen, hydroxyl, trifluoromethyl, cyano, nitro, substituted or unsubstituted alkyl, substituted or unsubstituted cycloalkyl, substituted or unsubstituted heteroalkyl, substituted or unsubstituted alkenyl, substituted or unsubstituted cycloalkenyl, substituted or unsubstituted heteroalkenyl, substituted or unsubstituted alkynyl, substituted or unsubstituted cycloalkynyl, substituted or unsubstituted heteroalkynyl, substituted or unsubstituted amino, substituted or unsubstituted aryl, substituted or unsubstituted heteroaryl, substituted or unsubstituted alkoxyl, substituted or unsubstituted aryloxyl, substituted or unsubstituted carbonyl, or substituted or unsubstituted carboxyl; and
R³, R⁴, R⁵, and R⁶ are each independently selected from hydrogen, substituted or unsubstituted alkyl, substituted or unsubstituted cycloalkyl, substituted or unsubstituted heteroalkyl, substituted or unsubstituted alkenyl, substituted or unsubstituted cycloalkenyl, substituted or unsubstituted heteroalkenyl, substituted or unsubstituted alkynyl, substituted or unsubstituted cycloalkynyl, substituted or unsubstituted heteroalkynyl, substituted or unsubstituted aryl, or substituted or unsubstituted heteroaryl.

19. The composition of claim 18, wherein R¹, R², R³, R⁴, R⁵, and R⁶ are each independently selected from hydrogen and substituted or unsubstituted C₁-C₆ alkyl.

20. The composition of claim 18, wherein R⁴ and R⁵ are hydrogen.

21. The composition of claim 18, wherein R¹, R², R³, and R⁶ are each independently selected from hydrogen and methyl.

22. The composition of claim 17, wherein the Cu^{+/++} boosting therapeutic has the following structure:

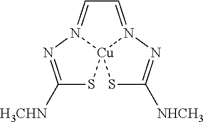

23. The composition of claim 17, wherein the Cu^{+/++} boosting therapeutic has the following structure:

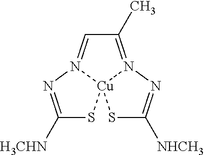

24. The composition of claim 17, wherein the Cu^{+/++} boosting therapeutic has the following structure:

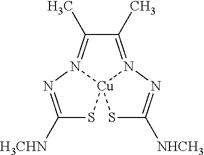

25. The composition of claim 17, wherein the Cu^{+/++} boosting therapeutic is disulfiram pre-complexed with Cu²⁻.

26. The composition of claim 25, wherein the Cu^{+/++} boosting therapeutic is a complex of the following structure:

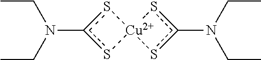

27. The composition of claim 15, further comprising a supplement capable of increasing Cu^{+/++} availability.

28. A method of screening for a Cu^{+/++} boosting therapeutic, wherein the method comprises:
(a) administering an agent to a Mycobacterium cultured in two different culture conditions, wherein a first culture condition is a Cu^{+/++} low/free media and a second culture condition is a Cu^{|/|} boosted media; and
(b) determining a level of viability of the Mycobacterium in each culture condition, wherein a decrease in the level of viability in the Cu^{+/++} boosted media compared to the level of viability in the Cu^{+/++} low/free media indicates that the agent is a Cu^{+/++} boosting therapeutic.

29. The method of claim 28, wherein the Mycobacterium is present in a Hartman/deBont medium supplemented with tyloxapol.
